(19) United States
(12) Patent Application Publication
(10) Pub. No.: US 2025/0289648 A1
(43) Pub. Date: Sep. 18, 2025

(54) PORTABLE BAG DISPENSER UNIT

(71) Applicant: ANGELCARE CANADA INC, Montreal (CA)

(72) Inventor: Michel MORAND, Montreal (CA)

(21) Appl. No.: 19/077,608

(22) Filed: Mar. 12, 2025

Related U.S. Application Data
(60) Provisional application No. 63/563,992, filed on Mar. 12, 2024.

(51) Int. Cl. B65D 83/08; B65F 1/00; E01H 1/12

(52) U.S. Cl. CPC B65D 83/0805; B65F 1/0006; E01H 1/1206; B65F 2240/136; E01H 2001/124; E01H 2001/128

(57) ABSTRACT

A bag dispenser unit for dispensing bags may have a casing having an inner cavity for receiving a roll of bags and defining an opening for outletting a free end of the roll of bags to dispense bags. A cap mechanism may be rotatably mounted to the casing in a first rotational degree of freedom, the cap mechanism having a shutter portion sized to close the opening, the cap mechanism rotatable between a first orientation in which the shutter portion closes the opening, and a second orientation in which the shutter portion is away from the opening. An axle rotatably may be mounted to the casing or the cap mechanism in a second rotational degree of freedom and having an axle support configured to be engaged with an interior of the roll of bags.

### CROSS-REFERENCE TO RELATED APPLICATION

The present application claims the benefit of U.S. Patent Application No. 63/563,992, filed on Mar. 12, 2024, the contents of which is incorporated herein by reference.

### FIELD OF THE DISCLOSURE

The present application relates to a portable bag dispenser unit supporting a plurality of bags for the dispensing thereof, known as dog poop bags.

### BACKGROUND OF THE ART

In various circumstances, there is often a need to carry bags in order to dispose of odorous waste. For example, because of municipal regulations, dog waste must be picked up by the guardian of the dog. In another example, it may occur that diapers with feces must be disposed of, away from household diaper disposal systems. However, by simply throwing waste with feces into typical garbage cans, the odors emanating from the waste will hardly be bearable over time. It is therefore desired to sealingly wrap or bag such odorous waste items individually to prevent this problem.

In some instances, bags for diaper disposal systems use types of polymers having specific airtightness characteristics, to retain the odors in the sealed bag. One copolymer commonly used for this purpose is an ethylene vinyl alcohol copolymer (also known as EVOH). However, such polymers are relatively expensive, whereby their use must be maximized.

Dispensing devices and bag rolls therefor have been devised to dispense single-use bags to collect waste. However, known dispensing devices may be hard to manipulate, and may expose the bag rolls to child maneuvers and to the elements.

### SUMMARY OF THE APPLICATION

It is a feature of the present disclosure to provide a novel bag dispenser unit.

It is another feature of the present disclosure to provide a novel method for dispensing bags from a bag dispenser unit.

It is another feature of the present disclosure to provide a novel method for installing bag rolls into a portable dispenser unit.

Therefore, in accordance with a first aspect, there is provided a method for dispensing a bag from a bag dispenser unit comprising: moving a shutter away from an opening of the bag dispenser unit to expose a bag roll inside the bag dispenser unit; grasping a bag from the bag roll from an interior of the bag dispenser unit via the opening; pulling the bag out of the bag dispenser unit to unroll the bag from the bag roll; and detaching the bag from the bag roll.

Further in accordance with the first aspect, for instance, the bag is unfolded from a folded condition.

Still further in accordance with the first aspect, for instance, the bag is opened from a sheet condition.

Still further in accordance with the first aspect, for instance, a hand is inserted in the bag and waste is picked up with the hand shielded by the bag.

Still further in accordance with the first aspect, for instance, the hand is removed from the bag and the bag is turned inside out for the waste to be captured in the reversed bag.

Still further in accordance with the first aspect, for instance, a free end of the bag roll is spooled into the bag dispenser unit after the detaching.

Still further in accordance with the first aspect, for instance, spooling the free end of the bag roll includes rotating an axle of the bag dispenser unit about a rotational axis A.

Still further in accordance with the first aspect, for instance, moving the shutter away from the opening includes rotating the shutter.

Still further in accordance with the first aspect, for instance, rotating the shutter includes rotating the shutter about said rotational axis A.

Still further in accordance with the first aspect, for instance, the opening is closed with the shutter after the detaching.

Still further in accordance with the first aspect, for instance, moving the shutter away from the opening includes rotating the shutter.

Still further in accordance with the first aspect, for instance, the bag roll is inserted into the bag dispenser unit bia the opening.

In accordance with a second aspect of the present disclosure, there is provided a bag dispenser unit for dispensing bags comprising: a casing having an inner cavity for receiving a roll of bags and defining an opening for outletting a free end of the roll of bags to dispense bags; a cap mechanism rotatably mounted to the casing in a first rotational degree of freedom, the cap mechanism having a shutter portion sized to close the opening, the cap mechanism rotatable between a first orientation in which the shutter portion closes the opening, and a second orientation in which the shutter portion is away from the opening; and an axle rotatably mounted to the casing or the cap mechanism in a second rotational degree of freedom and having an axle support configured to be engaged with an interior of the roll of bags.

Further in accordance with the second aspect, for instance, the axle is rotatably mounted to the cap mechanism.

Still further in accordance with the second aspect, for instance, the axle has a knob on an outside of the cap mechanism.

Still further in accordance with the second aspect, for instance, the cap mechanism is rotatably mounted to the casing about rotational axis A, and the axle rotates about the rotational axis A.

Still further in accordance with the second aspect, for instance, the opening extends between 120 degrees to 180 degrees of a circumference of the casing.

Still further in accordance with the second aspect, for instance, the cap mechanism is snap-fitted to the casing.

Still further in accordance with the second aspect, for instance, the cap mechanism has an arch-shape handle by which the cap mechanism is rotatable relative to the casing.

Still further in accordance with the second aspect, for instance, wherein the arch-shape handle has a slit.

In accordance with a third aspect of the present disclosure, there is provided a method for installing a bag roll in a bag dispenser unit comprising: moving the bag roll into the opening for one of the axle supports to penetrate a central passage of the bag roll at a first end of the bag roll; sliding the bag roll along the one of the axle supports to enable displacing a second end of the bag roll in alignment with the other of the axle supports; and sliding the bag roll for the other of the axle supports to penetrate the central passage of the bag roll at the second end of the bag roll.

Further in accordance with the third aspect, for instance, a shutter away is moved from the opening of the bag dispenser unit to expose the pair of axle supports inside the bag dispenser unit, prior to moving the bag roll into the opening.

Still further in accordance with the third aspect, for instance, the opening of the bag dispenser unit is closed with the shutter.

Still further in accordance with the third aspect, for instance, moving the shutter away includes rotating the shutter.

### BRIEF DESCRIPTION OF DRAWINGS

FIG. 1 is an elevation view of a portable bag dispenser unit in accordance with an embodiment of the present disclosure;

FIG. 2 is an exploded view of the portable bag dispenser unit of FIG. 1;

FIG. 3 is a sectional view of the portable bag dispenser unit of FIG. 1;

FIGS. 4A-4C are perspective views showing a sequence of closing a shutter of the portable bag dispenser unit of FIG. 1;

FIG. 5 is a side view of the portable bag dispenser unit of FIG. 1 showing access to a bag roll;

FIG. 6A is a perspective view of the portable bag dispenser unit of FIG. 1, with an additional;

FIG. 6B is an elevation view of the portable bag dispenser unit of FIG. 6A;

FIG. 7 is a schematic view of an exemplary bag roll that may be used with the portable bag dispenser unit of FIG. 1 or FIGS. 6A and 6B;

FIG. 8 is a schematic view of a pair of bags of the bag roll of FIG. 7; and

FIG. 9 is an elevation view of an exemplary bag roll that may be used with the portable bag dispenser unit of FIG. 1 or FIGS. 6A and 6B.

### DETAILED DESCRIPTION

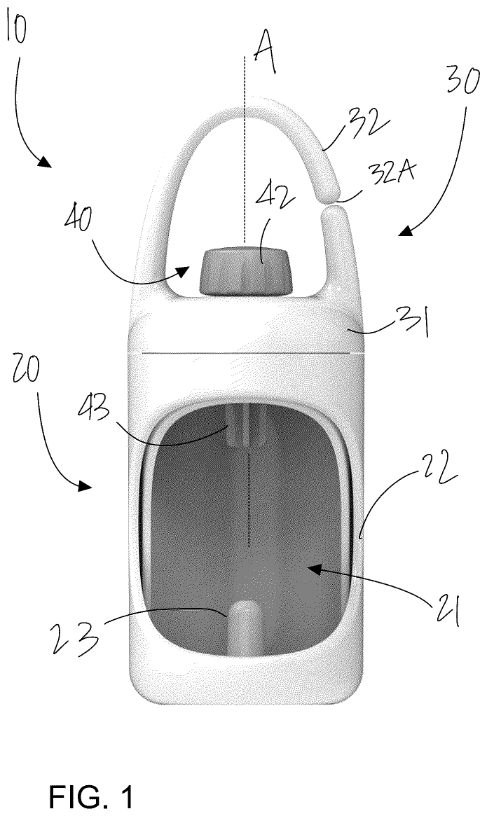

Referring to the drawings and, more particularly to FIG. 1, there is illustrated a portable bag dispenser unit 10 that is used to dispense bags, such as bags from a bag roll. The portable bag dispenser unit 10 is said to be portable, in that is relatively small and lightweight, and has an attachment feature.

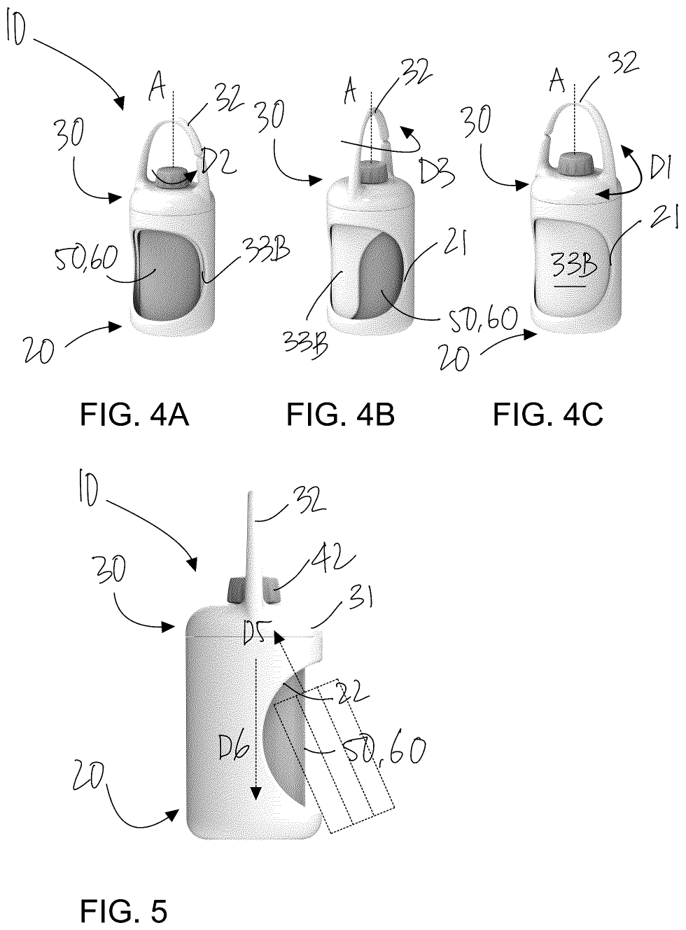

Referring concurrently to FIGS. 1 to 3, the bag dispenser unit 10 is shown having a hollow casing 20, a cap mechanism 30, and an axle 40. The hollow casing 20 accommodates the bag roll 50 (FIGS. 4A, 4B and 5). The cap mechanism 30 is rotatably mounted to the hollow casing 20, and is manipulated to cause movement of a shutter as described below, to enable access to an interior of the hollow casing 20. The cap mechanism 30 may also include a handle or like interface, though it could be on the hollow casing 20 and/or the axle 40. The axle 40 is rotatably connected to the cap mechanism 30, but could alternatively be rotatably connected to the casing 20, such as at a bottom of the casing 20 or to an internal structure of the casing 20. The axle 40 is manipulable to spool bag into the portable bag dispenser unit 10. The axle 40 is also manipulable to optionally align a free end of bag with an opening of the casing 20.

Referring to FIGS. 1-3, the hollow casing 20 has an inner cavity 21, sized so as to accommodate a bag roll. In an embodiment, the casing 20 is releasably interconnected with the cap mechanism 30, so as to be separable from it to optionally insert a bag roll into the bag dispenser unit 10. However, as described below, it may not be necessary to separate the casing 20 from the cap mechanism 30 to position a bag therein. According to an embodiment, the hollow casing 20 and the cap mechanism 30 are made of a molded polymer, such as by each being a monoblock. Any other appropriate construction and materials (e.g., metal) are also considered.

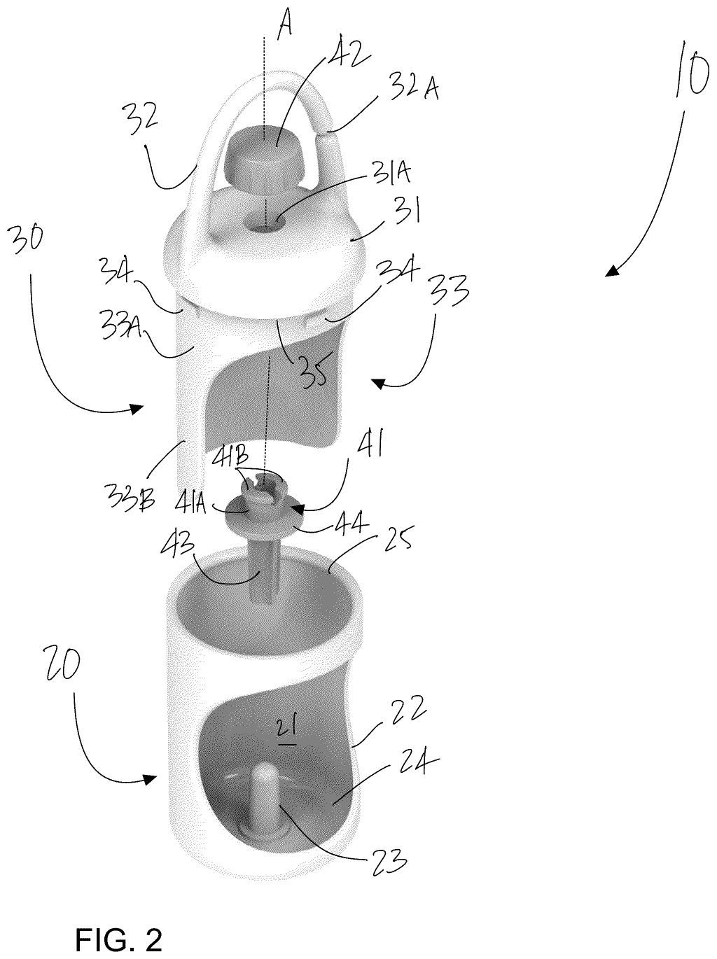

For illustrative purposes, a rotational axis is shown at A and represents the axis about which the cap mechanism 30 may rotate relative to the casing 20, and also an axis about which a bag roll rotates when inserted into the casing 20, such axes being coincident and shown as A. Rotational axis A may thus be referred to in the singular in the present disclosure as it could be said that is common to both rotational degrees of freedom, i.e., that of the cap mechanism 30 relative to the casing 20, and that of the axle 40 relative to the casing 20 and/or to the cap mechanism 30. There may also be separate axes, though the coincidence of axes (i.e., the rotational axis A being common to both rotations) may contribute to the compactness of the portable bag dispenser unit 10. As shown in FIG. 1, the casing 20 has a dispensing opening 22 defined therein. The dispensing opening 22 has an oval shape having a longitudinal direction generally parallel to the rotational axis A. Although an oval shape is shown, any other appropriate shape may be used for the dispensing opening 22. It is considered to shape the opening 22 with ornamental outlines. As observed from FIGS. 2 and 5, the opening 22 is a relatively wide opening, in that it covers at least 120 degrees of the 360 degrees of the circumferential surface, and may be between 120 degrees and 180 degrees, though it may be also be more or less. In terms of height (i.e., in a direction parallel to axis A), the opening 22 may extend for at least 50% of the total height of the casing 20.

Although not shown, a clip may be provided on a side of the casing 20 opposite the dispensing opening 22. The clip would have some level of resilience by its cantilevered construction, allowing the casing 20 to be clipped, for instance, to a belt, a leash or a strap.

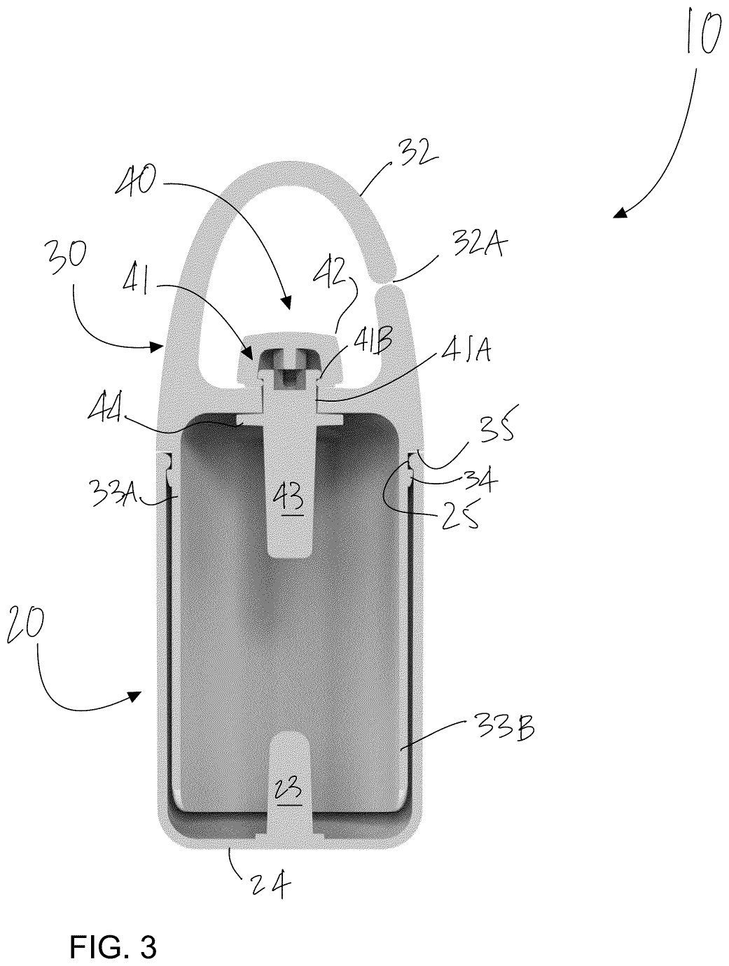

An axle support 23 may project from a bottom wall 24 of the casing 20, within the cavity 21. As observed, the axle support 23 may be an integral part of the casing 20, such as by being part of the monoblock body (if the casing 20 has a monoblock body). The axle support 23 may serve as rotational support for the bag roll in the cavity 21, and may be referred to as a hub, an axle, a support axle, a pivot, etc. In a variant, it has a frustoconical portion, to facilitation the positioning of a roll of bags thereon, with a top dome. Other shapes include cylindrical, for example. The casing 20 defines an open end, shown as being circular in shape. The open end may be delimited by an edge 25. The edge 25 may project radially inwardly, so as to define a flange or any other inward projection relative to an inner surface of the casing 20 as observed in FIG. 3. Instead of a continuous flange, the inward projection could be a tab or series of tabs, etc. Moreover, while the edge 25 defines a flange that acts as inward projection, the inward projection may be lower than the edge 25, and could be embodied as an inward rib, for example. The inward projection will be part of a rotational joint formed between the casing 20 and the cap mechanism 30.

Still referring to FIGS. 1 to 3, the cap mechanism 30 has a cap portion 31. The cap portion 31 may, at its base, have a cross-section generally equal to that of the casing 20, for a generally continuous surface to be formed between them when the casing 20 and the cap mechanism 30 are assembled. This is optional. The cap mechanism 30 may have a central bore 31A in the cap portion 31, for the axle 40, as described below. A handle 32 may project from a surface of the cap portion 31. The handle 32 is optional, but may conveniently be used to attach the portable bag dispenser unit 10 to a leash, to a belt, etc. The handle 32 may not be continuous, in that it may have a small slit 32A, to insert a leash or belt into the handle 32. In a variant, the material of the handle 32 may be selected to allow elastic deformation such that the handle 32 may be hooked to a larger object. Moreover, it is also considered to provide a spring loaded clip, such as in a carabiner, to allow the handle 32 to define a larger opening than the slit 32A, for the larger objects or structures to enter the hoop of the handle 32 and be held captive in the hoop thereafter.

The cap mechanism 30 may further include a skirt 33 or like downward projection, that is sized to fit in the cavity 21 of the casing 20. In a variant, the skirt 33 may include a rotational joint portion 33A, adjacent to the cap portion 31, and a shutter portion 33B. The rotational joint portion 33A is for example cylindrical, though this is optional. Tabs 34 may be present on an outer cylindrical surface of the rotational joint portion 33A. The tabs 34 will cooperate with the edge 25 of the casing 20 to help retain the casing 20 captive with the cap mechanism 30, while enabling rotation. The tabs 34 may be wedges that taper in a downward direction, to facilitate the clipping of the cap mechanism 30 to the casing 20, by the tabs 34 sliding against the edge 25 for the edge 25 to then be lodged between the tabs 34 and a shoulder 35. As an alternative to the discrete tabs 34, an inner rib could be present for the same purpose. The shoulder 35, at a junction between the cap portion 31 and the shirt 33, may lay in sliding rotation against the edge 25 of the casing 20. The shoulder 35 may optionally be an annular surface lying in a plane to which a vector of the rotational axis A is normal. Other arrangements are possible.

To assemble the casing 20 to the cap mechanism 30, the skirt 33 may be inserted into the top open end of the casing 20. The cap mechanism 30 may then be moved further into the casing 20 until the tabs 34 clip onto the inward projection of the casing 20, e.g., the edge 25. The clipping may rely on elastic deformation, and a reverse movement can be performed to disengage the cap mechanism 30 from the casing 20. This may include pulling on the handle 32.

Accordingly, when the cap mechanism 30 is connected to the casing 20, a rotational joint is formed therebetween, with rotation about axis A being possible. A user may optionally manipulate the cap mechanism 30 to cause the rotation. FIGS. 4A to 4B show different orientations of the cap mechanism 30 relative to the casing 20. As observed, the shutter 33B is sized so as to completely shut the dispensing opening 22, as in FIG. 4C. Hence, in a variant, the peripheral width of the shutter portion 33B is greater than that of the opening 22. The orientation of FIG. 4C may be the desired orientation in most situations—i.e., the normal closed orientation—, so as to prevent tampering with the bag inside the portable bag dispenser unit 10, and/or to protect the bag roll from the elements (e.g., rain). In FIG. 4A, it can be observed that the shutter 33B does not provide any obstruction, even though the dispensing opening 22 is relatively large. This facilitates the user's grabbing and pulling of a bag free end from a bag roll 50 inside the portable bag dispenser unit 10. This may be expressed as the combination of the peripheral width of the opening 22 and of the shutter portion 33B being less than the total peripheral width of the casing 20. The peripheral width may be in a plane to which the rotational axis A is normal. Alternatively, in some configurations, the shutter portion 33B could be pulled or translated into the closing or opening of the opening 22.

The fitting between the casing 20 and the cap mechanism 30 are such that some friction is present against the rotation of the cap mechanism 30 relative to the casing 20. The friction is sufficiently high that a manipulation may be required to cause the rotation. This is optional.

Referring to FIGS. 2 and 3, the axle 40 is shown as having an axle portion 41 that is rotatably mounted to the cap portion 31, in the central bore 31A. The axle portion 41 may for example have a cylindrical portion 41A rotatably received in the central bore 31A. Two or more legs 41B, each ending with a flange or like lip may project upwardly from the cylindrical portion 41A. The legs 41B are consequently separated by a gap, so as to allow their deflection when a knob 42 is clipped onto the legs 41B, as in FIG. 3. The knob 42 may have have surface features to facilitate its handling during rotation of the axle 40 relative to the cap mechanism 30, the rotation being for example about rotational axis A. In a variant, there is no cylindrical portion 41A, as the axle portion 41 may be defined solely by the legs 41B. In another variant, there are no legs 41B. For example, the cylindrical portion 41A may have a central bore for the knob 42 to be attached to the central bore, e.g., by threading engagement, etc. Other ways are contemplated to attach the knob 42 to the axle portion 41.

A flange 44 may be provided between the axle portion 41 and an axle support 43. The flange 44 serves as an abutment to limit the penetration of the axle portion 41 into the central bore 31A of the cap portion 31. The flange 44 and the knob 42 may cooperate for the assembly of the axle 40 to be held captive yet free to rotate relative to the cap portion 31. The flange 44 could be a shoulder, tabs, ribs, etc. The axle support 43 is provided to interface with the roll of bags that will be rotatably mounted to the axle 40. The axle support 43 may not be circular in shape, as it must impart a rotation to the roll of bags. As observed in FIG. 2, an exemplary shape for the axle support 43 is a three-tiered shape, as a possibility among others. The axle support 43 may taper downwardly, toward the axle support 23. Hence, when a roll of bags is operationally in the casing 20, it is held between the axle support 23 and the axle support 43. The user may rotate the knob 42 to cause a rotation of the roll of bags 50. This may be done to spool the roll of bags 50 back into the casing 20, when a free end of the roll of bags 50 is outside of the portable bag dispenser unit 10.

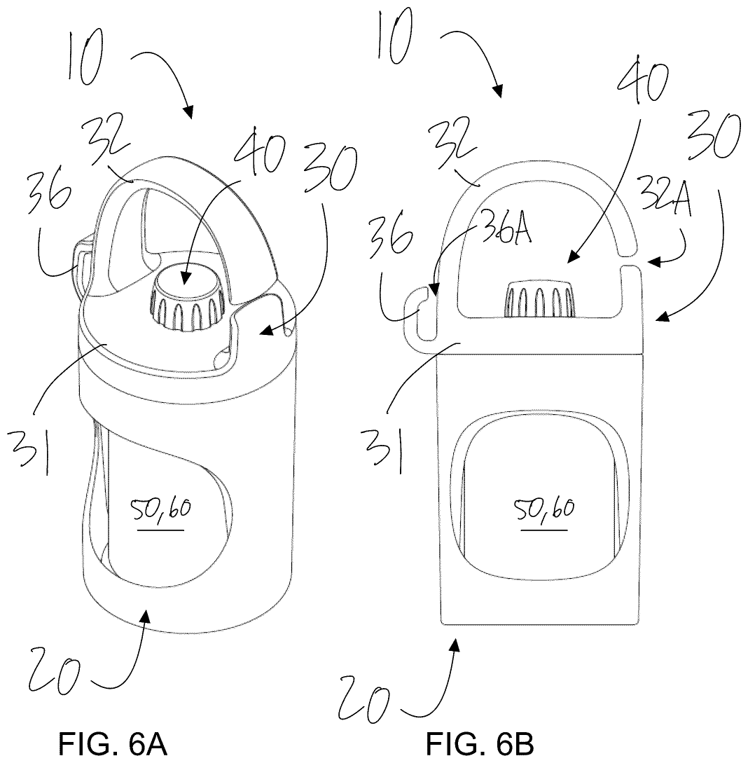

Referring to FIGS. 6A and 6B, the portable bag dispenser unit 10 is shown, but with an additional hook 36 projecting from a side of the cap portion 31. The additional hook 36 may be monoblock with the cap portion 31, or could be a separate component. The hook 36 may define a throat 36A with a periphery of the cap portion 31, such that objects attached to the hook 36 may be held captive to it. The hook 36 may also rely on its elastic deformation to allow objects to be hooked to it. In a variant, the hook 36 lies in a common plane with the handle 32 and the rotational axis A. The hook 36 may be on a side opposite the slit 32A, i.e., they may be said to be diametrically opposed. It is also considered to provide the hook 36 on the casing 20. In a variant, the hook 36 is for a bag of waste, such as a poop bag. The bag of waste may be hooked onto the hook 36 until a garbage pail is found.

Accordingly, the portable bag dispenser unit 10 may be said to have two rotational degrees of freedom, independent from one another. The rotational degrees of freedom may be about the same axis of rotation, e.g., rotational axis A, but this is merely optional. The axes of the rotational degrees of freedom may lie in a same plane if not coincident. One of the rotational degrees of freedom being that of the cap mechanism 30 relative to the casing 20, for the opening and closing of the opening 22 with the shutter portion 33B, and another for the rotation of the axle 40 relative to the cap mechanism 30, for the spooling of the bag of rolls 50. The rotational degrees of freedom are said to be independent, as one rotation may occur without the other. Frictional forces may be such that a rotation of the cap mechanism 30 relative to the casing 20 may cause a rotation of the axle 40. Nevertheless, the rotational degrees of freedom may be regarded as being independent.

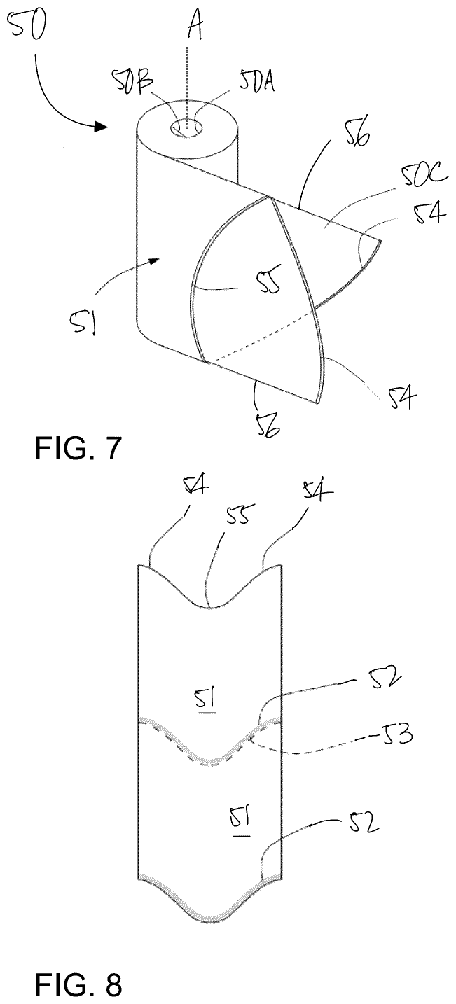

Referring concurrently to FIGS. 7 and 8, there is illustrated the bag roll 50, in accordance with one embodiment. The bag roll 50 has a tube 50A supporting a length of bags 51 or like central opening. The tube 50A is mounted about the rotational axis A, when the bag roll 14 is in the casing 20. More particularly, the axle supports 23 and 43 are received in opposite ends of the tube 50A. Accordingly, the bag roll 14 may rotate about the rotational axis A. To have the bag roll 50 and axle 40 rotate concurrently, the tube 50A may have an inner contact surface 50B that will come into an abutment relation with a complementary surface on the axle 40. Other configurations are also considered for the concurrent rotation of the axle 40 with the bag roll 50, including any form of mating engagement and/or frictional forces.

The length of bags 51 is typically a length of a tubular material, in a sheet condition. The tubular material is perforated and sealed width-wise to define a plurality of bags 51 connected end to end, namely with the segment of bags between sets of a seam and a tearing line. The bags 51 are separated by a seam 52 made by the sealing of the tubular material. Accordingly, the seam 52 defines a bottom of the bag. In the roll, the seam 52 is adjacent to a tearing line 53 (resulting from the perforating), with the tearing line 53 being the joint between a pair of bags 51. Therefore, a bag at a free end of the bag roll 50C may be torn off a remainder of the bag roll 50 for use.

In the illustrated embodiment of FIG. 7, the free end 50C is defined by an open end of one of the bags 51 (i.e., opposite the seam 52), but could also be defined by the closed end of one of the bags 51 (i.e., with the seam 52).

The tubular sheet may be of any appropriate polymeric material, in one or multiple layers. Considering the odorous nature of some waste items that may be wrapped in the bag 51, a layer of an ethylene vinyl alcohol copolymer, among other possibilities, may be used. Any other suitable sheet polymer or sheet fibers could be used for the bag roll 50.

According to an embodiment, the tear-off strip 53 has a specific pattern to optimize the use of the bag 51. The pattern at the top open edge of the bag 51 (i.e., the edge opposite to the seam 52) defines a depression, illustrated by a pair of peaks 54 adjacent to the lateral sides of the bag 51, with the peaks 54 separated by a valley 55. Accordingly, the depression of the top open edge of the bag 51 is defined by a generally central portion thereof being lower than the peaks adjacent to the lateral sides of the bag 51.

As the bag 51 is in the roll 50, the depression pattern of the top open edge results in a protrusion (a.k.a., nose, projection, convexity) projecting downwardly at the bottom closed edge of the bag 51, as the bags 51 are sequentially connected top to bottom in the roll 50. In this configuration of mating bottom edge and top edge of adjacent bags 51, there is no waste of plastic for each bag 51 that is perforated into the tubular sheet. More specifically, considering that the bag 51 of an embodiment has a uniform height, and considering the mating outlines of bags 51 interconnected end to end, there is no waste of bag material as there would be if the bag 51 had a straight bottom edge. However, it is also considered to have a straight bottom edge for the bags 51, with a cutout of the tubular material allowing the depression to be formed at the top open edge.

Although the peaks-and-valley depression edge of the bag 51 is shown with a sinusoidal outline in the illustrations, the peaks-and-valley edge may also have other outlines, such as a square waveform, a triangular waveform, among numerous other possibilities. The peaks 52 may also be offset vertically from one another. Moreover, the bag 51 may be rectangular in outline, or may have any other appropriate shape.

In order for the bag roll 50 to be compact, it may be folded on itself in a lengthwise direction. The fold lines are shown at 56, with two fold lines 56 being present. The fold lines are optional, but one or more of the fold lines 56 being possible.

Referring to FIG. 7, the specific shape of the bag 51 is ergonomically efficient when the bag 51 is used as a mitt for hand, such as when dog poop is to be picked up. The thumb may lodge in a corner of the bag 51, while the remainder of the fingers are in the nose at the bottom of the bag 51 (i.e., central projection), thereby facilitating the manipulation and grasping of objects with the bag 51. Accordingly, typical suitable dimensions for the bag 51 are a width ranging between 7 inches and 12 inches, and the height of the lateral edges range between 8 inches and 12 inches. However, other dimensions may be used, depending on the application. These dimensions apply to rectangular shapes for the bag 51.

Therefore, when the bag 51 is used as a mitt (including for a rectangular bag), once the waste has been collected, the 51 is turned inside out with the waste being captured inside as a result of the operation. The bag 51 is then tied up, forming a knot in the manner described above.

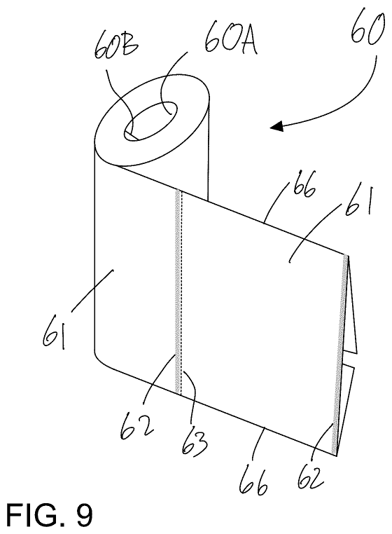

The portable bag dispenser unit 10 may use other types of bags, such as rectangular bags in a roll as shown at 60 in FIG. 9. The bag roll 60 has a tube 60A supporting a length of bags 61. The tube 60A is mounted about the rotational axis A, when the bag roll 14 is in the casing 20. More particularly, the axle supports 23 and 43 are received in opposite ends of the tube 60A. Accordingly, the bag roll 14 may rotate about the rotational axis A. To have the bag roll 60 and axle 40 rotate concurrently, the tube 60A may have an inner contact surface 60B that will come into an abutment relation with a complementary surface on the axle 40. Other configurations are also considered for the concurrent rotation of the axle 40 with the bag roll 60, including any form of mating engagement and/or frictional forces.

The length of bags 61 is typically a length of a tubular material, in a sheet condition. The tubular material is perforated and sealed width-wise to define a plurality of bags 61 connected end to end, namely with the segment of bags between sets of a seam and a tearing line. The bags 61 are separated by a seam 62 made by the sealing of the tubular material. Accordingly, the seam 62 defines a bottom of the bag. In the roll, the seam 62 is adjacent to a tearing line 63 (resulting from the perforating), with the tearing line 63 being the joint between a pair of bags 61. Therefore, a bag at a free end of the bag roll 60C may be torn off a remainder of the bag roll 60 for use. In order for the bag roll 60 to be compact, it may be folded on itself in a lengthwise direction. The fold lines are shown at 66, with two fold lines 66 being present. The fold lines are optional, but one or more of the fold lines 66 being possible.

Now that the portable bag dispenser unit 10 has been described, a method for dispensing bag from the portable bag dispenser unit 10, or like bag dispenser unit, is described.

The portable bag dispenser unit 10 may be empty and may require that a bag roll, such as bag roll 50, be inserted therein. In one way to insert the bag roll, the shutter is moved away from an opening of the bag dispenser unit, such as by being rotated, to expose an inside of the bag dispenser unit. The bag roll may be inserted via the opening, and installed on a first of the axle support 23 and 43, and then slid down on the other. In a variant, the casing 20 and the cap mechanism 30 are separated from one another. The bag roll 50,60 is mounted onto the axle support in the cavity 21 of the casing 20, and the cap mechanism 30 is connected onto the casing 20 by inserting the shutter portion 33B into the cavity of the casing 20. The cap mechanism 30 is then pushed until the rotational joint is formed, such as by snap-fitting.

To dispense a bag, the shutter may be moved away from an opening of the bag dispenser unit to expose a bag roll inside the bag dispenser unit. For instance this is shown by directions D1 in FIG. 4C, leading to the arrangement of FIG. 4A. Then, a bag may be grasped from the bag roll from an interior of the bag dispenser unit via the opening. The bag may be pulled out of the bag dispenser unit to unroll the bag from the bag roll. The bag may be detached from the bag roll.

Depending on the configuration of the portable bag dispenser unit and/or of the bag roll 50, the bag may be unfolded from a folded condition, as it is in FIGS. 7 and 9. A user may open the bag from its sheet condition, and may optionally insert his/her hand in the bag and pick up waste with the hand shielded by the bag, but this is optional. Alternatively, the waste may be deposited in the open bag. If used as a glove, the hand may be removed from the bag and the bag may be turned inside out for the waste to be captured in the reversed bag.

A free end of the bag roll may be spooled back into the bag dispenser unit after the detaching. Spooling the free end of the bag roll may include rotating an axle of the bag dispenser unit about a rotational axis A, such as according to direction D2 in FIG. 4A. Moving the shutter away from the opening may include rotating the shutter. Rotating the shutter may include rotating the shutter about said rotational axis A. Optionally, the opening of the portable bag dispenser unit may be closed with the shutter after the detaching. The closing may include rotating the shutter, such as shown as direction D3 in FIG. 4B.

The portable bag dispenser unit 10 may generally be described as having: a casing having an inner cavity for receiving a roll of bags and defining an opening for outletting a free end of the roll of bags to dispense bags; a cap mechanism rotatably mounted to the casing in a first rotational degree of freedom, the cap mechanism having a shutter portion sized to close the opening, the cap mechanism rotatable between a first orientation in which the shutter portion closes the opening, and a second orientation in which the shutter portion is away from the opening; and an axle rotatably mounted to the casing or the cap mechanism in a second rotational degree of freedom and having an axle support configured to be engaged with an interior of the roll of bags. In a variant, the axle is rotatably mounted to the cap mechanism. The axle may have a knob on an outside of the cap mechanism. The cap mechanism is rotatably mounted to the casing about rotational axis A, and the axle rotates about the rotational axis A. The opening may extend between 120 degrees to 180 degrees of a circumference of the casing. The cap mechanism may be snap-fitted to the casing. The cap mechanism may have an arch-shape handle by which the cap mechanism is rotatable relative to the casing. The arch-shape handle may have a slit.

The bag dispenser unit for dispensing bags may therefore generally be described as having casing defining an inner cavity for receiving a roll of bags and defining an opening for outletting a free end of the roll of bags to dispense bags; a cap mechanism rotatably mounted to the casing in a first rotational degree of freedom, the cap mechanism having a shutter portion sized to close the opening, the cap mechanism rotatable between a first orientation in which the shutter portion closes the opening, and a second orientation in which the shutter portion is away from the opening; and an axle rotatably mounted to the casing or the cap mechanism in a second rotational degree of freedom and having an axle support configured to be engaged with an interior of the roll of bags.

The present disclosure includes a method for dispensing a bag from a bag dispenser unit, such as the one shown as 10. The method may include moving a shutter away from an opening of the bag dispenser unit to expose a bag roll inside the bag dispenser unit; grasping a bag from the bag roll from an interior of the bag dispenser unit via the opening; pulling the bag out of the bag dispenser unit to unroll the bag from the bag roll; and detaching the bag from the bag roll.

The present disclosure may further include a method for installing a bag roll in a bag dispenser unit, such as the one shown at 10. The method may include: moving the bag roll into the opening for one of the axle supports to penetrate a central passage of the bag roll at a first end of the bag roll, such as shown as direction D5 in FIG. 5. The bag roll may be slid along the one of the axle supports to enable displacing a second end of the bag roll in alignment with the other of the axle supports. This may include a pivoting movement once a penetration depth is sufficient for the second end of the bag roll to be clear of the other axle support. The method may then include sliding the bag roll for the other of the axle supports to penetrate the central passage of the bag roll at the second end of the bag roll, such as shown as D6. The method may include moving a shutter away from the opening of the bag dispenser unit to expose the pair of axle supports inside the bag dispenser unit, prior to moving the bag roll into the opening; and/or closing the opening of the bag dispenser unit with the shutter; moving the shutter away may include rotating the shutter.

1. A method for dispensing a bag from a bag dispenser unit comprising:
moving a shutter away from an opening of the bag dispenser unit to expose a bag roll inside the bag dispenser unit;
grasping a bag from the bag roll from an interior of the bag dispenser unit via the opening;
pulling the bag out of the bag dispenser unit to unroll the bag from the bag roll; and
detaching the bag from the bag roll.

2. The method according to claim 1, further including unfolding the bag from a folded condition.

3. The method according to claim 1, further including opening the bag from a sheet condition.

4. The method according to claim 1, further including inserting a hand in the bag and picking up waste with the hand shielded by the bag.

5. The method according to claim 4, further including removing the hand from the bag and tuning the bag inside out for the waste to be captured in the reversed bag.

6. The method according to claim 1, further including spooling a free end of the bag roll into the bag dispenser unit after the detaching.

7. The method according to claim 6, wherein spooling the free end of the bag roll includes rotating an axle of the bag dispenser unit about a rotational axis A.

8. The method according to claim 7, wherein moving the shutter away from the opening includes rotating the shutter.

9. The method according to claim 8, wherein rotating the shutter includes rotating the shutter about said rotational axis A.

10. The method according to claim 1, further including closing the opening with the shutter after the detaching.

11. The method according to claim 1, wherein moving the shutter away from the opening includes rotating the shutter.

12. The method according to claim 1, further including inserting the bag roll into the bag dispenser unit bia the opening.

13. A bag dispenser unit for dispensing bags comprising:
a casing having an inner cavity for receiving a roll of bags and defining an opening for outletting a free end of the roll of bags to dispense bags;
a cap mechanism rotatably mounted to the casing in a first rotational degree of freedom, the cap mechanism having a shutter portion sized to close the opening, the cap mechanism rotatable between a first orientation in which the shutter portion closes the opening, and a second orientation in which the shutter portion is away from the opening; and
an axle rotatably mounted to the casing or the cap mechanism in a second rotational degree of freedom and having an axle support configured to be engaged with an interior of the roll of bags.

14. The bag dispenser unit according to claim 13, wherein the axle is rotatably mounted to the cap mechanism.

15. The bag dispenser unit according to claim 14, wherein the axle has a knob on an outside of the cap mechanism.

16. The bag dispenser unit according to claim 13, wherein the cap mechanism is rotatably mounted to the casing about rotational axis A, and the axle rotates about the rotational axis A.

17. The bag dispenser unit according to claim 13, wherein the opening extends between 120 degrees to 180 degrees of a circumference of the casing.

18. The bag dispenser unit according to claim 13, wherein the cap mechanism is snap-fitted to the casing.

19. The bag dispenser unit according to claim 13, wherein the cap mechanism has an arch-shape handle by which the cap mechanism is rotatable relative to the casing.

20. The bag dispenser unit according to claim 19, wherein the arch-shape handle has a slit.
